(19) United States
(12) Patent Application Publication
(10) Pub. No.: US 2011/0119896 A1
(43) Pub. Date: May 26, 2011

(54) METHOD OF MAKING AIR-FIRED CATHODE ASSEMBLIES IN FIELD EMISSION DEVICES

(75) Inventors: Ross Getty, Wilmington, DE (US); Phil Lynch, Rockland, DE (US)

(73) Assignee: E. I. DuPont De Nemours and Company, Wilmington, DE (US)

(21) Appl. No.: 13/054,522

(22) PCT Filed: Aug. 20, 2009
(86) PCT No.: PCT/US2009/054428

§ 371 Date: Jan. 17, 2011

Related U.S. Application Data
(60) Provisional application No. 61/091,130, filed on Aug. 22, 2008.
(60) Provisional application No. 61/091,114, filed on Aug. 22, 2008.

(51) Int. Cl. B23P 25/00; B05D 5/12; B82Y 30/00

(52) U.S. Cl. 29/458; 427/77; 427/78; 977/952; 977/932

(57) ABSTRACT

This invention relates a method for manufacturing cathode assemblies for field emission devices.

This application claims priority under 35 U.S.C. §119(e) from, and claims the benefit of, U.S. Provisional Application No. 61/091,114, filed 22 Aug. 2008, and U.S. Provisional Application No. 61/091,130, filed 22 Aug. 2008, each of which is by this reference incorporated in its entirety as a part hereof for all purposes.

### TECHNICAL FIELD

This invention relates to a method of manufacturing cathode assemblies for field emission devices.

### BACKGROUND

Field emission devices can be used in a variety of electronic applications such as vacuum electronic devices, flat panel computer and television displays, emission gate amplifiers and klystrons, and in lighting. Display screens are used in a wide variety of applications such as home and commercial televisions, laptop and desktop computers, and indoor and outdoor advertising and information presentations. Flat panel displays can be an inch or less in thickness in contrast to the deep cathode ray tube monitors found on many televisions and desktop computers. Flat panel displays are a necessity for laptop computers, but also provide advantages in weight and size for many other applications.

Currently laptop computer flat panel displays use liquid crystals, which can be switched from a transparent state to an opaque state by the application of small electrical signals. Plasma displays have been proposed as an alternative to liquid crystal displays. A plasma display uses tiny pixel cells of electrically charged gases to produce an image and requires relatively large electrical power to operate.

It has been proposed that flat panel displays be constructed by combining a field emission device containing a cathode assembly that contains an electron field emitter with a phosphor capable of emitting light upon bombardment by electrons emitted by the field emitter. Such displays have the potential for providing the visual display advantages of the conventional cathode ray tube together with the depth, weight and power consumption advantages of the other types of flat panel displays. U.S. Pat. Nos. 4,857,799 and 5,015,912 disclose matrix-addressed flat panel displays using micro-tip emitters constructed of tungsten, molybdenum or silicon.

WO 94/15352, WO 94/15350 and WO 94/28571 disclose flat panel displays wherein the cathode assemblies have relatively flat emission surfaces.

Field emission has been observed in two kinds of carbon nanotube structures. Chemozatonskii et al, in Chem. Phys. Letters 233 (1995) 63 and Mat. Res. Soc. Symp. Proc. 359 (1995) 99, have produced films of carbon nanotube structures on various substrates by the electron evaporation of graphite in an atmosphere of 10⁻⁵˜10⁻⁶ torr (1.3×10⁻³˜1.3×10⁻⁴ Pa). These films consist of aligned tube-like carbon molecules standing next to one another. Two types of tube-like molecules are formed: A-tubelites, whose structure includes single-layer graphite-like tubules forming filaments-bundles 10˜30 nm in diameter; and B-tubelites, which include mostly multilayer graphite-like tubes 10˜30 nm in diameter with conoid or dome-like caps. They report considerable field electron emission from the surface of these structures and attribute it to the high concentration of the field at the nanodimensional tips.

Rinzler et al, in Science 269 (1995) 1550, report that the field emission from carbon nanotubes is enhanced when the nanotubes tips are opened by laser evaporation or oxidative etching Zettl et al disclose in U.S. Pat. No. 6,057,637 an electron emitting material comprising a volume of binder and a volume of BₓC_{y}N_{z} nanotubes suspended in the binder, where x, y and z indicate the relative ratios of boron, carbon and nitrogen.

Choi et al, Appl. Phys. Lett. 75 (1999) 3129, and Chung et al, J. Vac. Sci. Technol. B 18(2), report the fabrication of a 4.5 inch flat panel field display using single-walled carbon nanotubes in organic binders. The single-walled carbon nanotubes were vertically aligned by squeezing paste through a metal mesh, by surface rubbing and/or by conditioning by electric field. They also prepared multi-walled carbon nanotube displays. They note that carbon nanotube electron emitting materials having good uniformity were developed using a slurry-squeezing and surface-rubbing technique. They found that removing metal powder from the uppermost surface of the emitter and aligning the carbon nanotubes by surface treatment enhanced the emission. Single-walled carbon nanotubes were found to have better emission properties than multi-walled carbon nanotubes, but single-walled carbon nanotube films showed less emission stability than multi-walled carbon nanotube films.

Yunjun Li et al disclose in U.S. Ser. No. 07/117,401 compositions of carbon nanotubes that may be dispensed as inks by a printing process to prepare a field emitting device. After the ink compositions have been dispensed, the device may be heated in one or more steps across a temperature regime to dry, bake and/or fire the device.

There is nevertheless a continuing need for technology enabling the commercial use of an acicular electron emitting material, such as carbon nanotubes, in an electron field emitter.

### BRIEF DESCRIPTION OF THE DRAWINGS AND FIGURES

FIG. 1 shows the layers forming the fully screen printed field emissive cathode for a triode display device.

FIG. 2 shows diode emission current as a function of alumina loading for a thick film emitter composition containing carbon nanotubes when fired at 420° C. in an atmosphere containing oxygen.

### SUMMARY

In one embodiment, this invention provides a method of depositing an electron emitting material on a substrate by (a) providing a substrate, (b) admixing components comprising (i) carbon nanotubes, (ii) alumina powder, and (iii) an organic vehicle to form a composition, (c) depositing a pattern of a thick film of the composition on the substrate, and (d) heating the pattern of the thick film at a temperature between 300° C. and 550° C. in an air or oxidizing atmosphere.

In another embodiment, this invention provides a field emitter, a cathode, a cathode assembly, a field emission device or a flat panel display that is obtained or obtainable by any of the above described methods.

In another embodiment, this invention provides a composition that includes (i) thin walled carbon nanotubes made by thermal chemical vapor deposition and (ii) an organic vehicle.

The carbon nanotubes are contained in a thick film paste. In a preferred embodiment, the paste further comprises alumina powder. The paste is prepared by providing thin walled carbon nanotubes, such as carbon nanotubes made by thermal chemical vapor deposition, for incorporation into the paste. The resulting thick film composition may be heated in air or an oxidizing atmosphere during the process of manufacture of the cathode assembly. A film printed from a paste prepared from carbon nanotubes, and alumina powder, need not be heated in nitrogen or an otherwise inert atmosphere, or in a vacuum, to avoid degradation of the emission current provided by the carbon nanotubes. The compositions hereof may be heated to between 300° C. and 550° C. in air or an oxidizing atmosphere without degradation.

### DETAILED DESCRIPTION

This invention involves a method to fabricate a cathode assembly that contains, in an electron field emitter therein, an acicular, carbon, electron emitting material such as carbon nanotubes (“CNTs”). In addition to an electron emitting material, an electron field emitter may also contain as optional components inorganic filler powders, which include metallic oxides such as alumina; glass fit; and metallic powder or metallic paint; or a mixture two or more thereof, all as more particularly described below.

An acicular, carbon, electron emitting material, as used herein in an electron field emitter, can be of various types. An acicular material is characterized by particles having an aspect ratio of 10 or more. Single-walled, double-walled, multi-walled, or thin-walled carbon nanotubes are especially preferred as the emitting material. The individual carbon nanotubes are extremely small, typically about 1.5 nm in diameter. The carbon nanotubes are sometimes described as graphite-like in reference, primarily, to the presence of sp² hybridized carbon therein. The wall of a carbon nanotube can be envisioned as a cylinder formed by rolling up a graphene sheet. Blends of different kinds of carbon nanotubes may be used as well.

While CNTs are the preferred acicular, carbon, electron emitting material for use in this invention, in alternative embodiments other acicular, carbon, emitting materials may be used including various types of carbon fibers such as polyacrylonitrile-based (PAN-based) carbon fibers and pitch-based carbon fibers. Carbon fibers useful herein include those grown from the catalytic decomposition of carbon-containing gases over small metal particles, such fibers typically having graphene platelets arranged at an angle with respect to the fiber axis so that the periphery of the carbon fiber consists essentially of the edges of the graphene platelets. The angle may be an acute angle or 90 degrees.

The high aspect ratio and sharp radius of curvature of an acicular, carbon, electron emitting material, such as described above, can produce high electric fields for an applied potential at the tip of the emitter. This can produce elevated field emission currents. The acicular carbon material may be contained, for example, in a thick film that contains an organic vehicle and, optionally, also an alumina powder. Applying a thick film to a substrate is a convenient method of patterning and attaching an electron emitting material to the substrate, securing its position on the substrate in place, and supplying for the emitting material conductivity to the required electrical potential. After deposition of a pattern of a thick film containing an emitting material by techniques such as screen printing, the pattern of the thick film is heated to consolidate the thick film and drive off the volatile components of the organic vehicle.

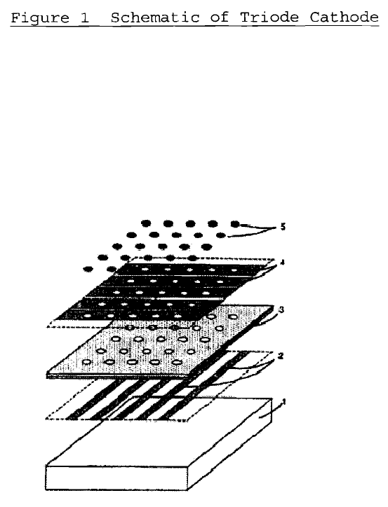

An electron field emitter, such as formed by a thick film process as described above, may be fabricated as part of a cathode assembly for a field emission device. One design for a cathode assembly suitable for use in this invention is shown in FIG. 1, which shows layers forming a screen printed, field emissive cathode assembly for a triode emitter device. Layer 1 is a glass substrate; layer 2 is a patterned cathode electrode in contact with the substrate; layer 3 is a dielectric layer with via openings in contact with layer 2; layer 4 is a gate electrode in contact with the top of the dielectric layer; and layer 5 is the electron emitting material printed as dots inside the vias of the dielectric layer.

To fabricate a field emissive cathode assembly, such as described above, a substrate is first provided. The substrate may be, and preferably is, an electrical insulator or be electrically insulating, and can be any material to which a paste composition will adhere. If the applied thick film paste is non-conducting and a non-conducting substrate is used, a film of an electrical conductor to serve as the cathode electrode and provide a voltage to the electron emitting material will be needed. Silicon, glass, metal or a refractory material such as alumina are examples of materials that can serve as the substrate. For display applications, the preferable substrate is glass, and soda lime glass is especially preferred. For optimum conductivity on glass, silver paste can be pre-fired onto the glass at 400-550° C. in air or nitrogen, but preferably in air. The conducting layer thus formed as the cathode electrode can then be over-printed with a paste containing the emitting material.

In alternative embodiments, however, a substrate may be electrically conductive.

At this stage, a patterned dielectric layer may be screen printed, patterned and fired over the patterned cathode electrode. Next, a patterned, conductive gate electrode layer may be screen printed, patterned and fired over the dielectric layer. The gate electrode may be deposited by a variety of techniques such as spraying, sputtering or any standard deposition process. Alternatively, a gate electrode may be provided at a later stage in the form of a mesh placed on top of the cathode assembly.

In the next step, a pattern of a thick film paste composition containing an electron emitting material, an organic vehicle and, optionally, alumina powder is deposited on the pattern of the electrical conductor. In the case of a triode cathode assembly, this thick film paste is typically deposited into vias in the dielectric layer. In the case of a diode cathode assembly, with no dielectric or gate layers, the thick film paste is deposited on the patterned conductor (i.e. the cathode electrode) that is in contact with the substrate. The organic vehicle may be screen printable or photopolymerizable. Application of the paste as a patterned thick film may be done by screen or stencil printing, photoimaging, ink jet deposition, or any standard deposition process.

The thick film paste used for screen printing typically contains, in addition to the electron emitting material: an organic medium; solvent; surfactant; optionally, either a low softening point glass frit, metallic powder or metallic paint or a mixture thereof; and, optionally alumina powder. A thick film paste from which an electron field emitter may be formed typically contains about 5 wt % to about 80 wt % solids based on the total weight of the paste. These solids typically include the electron emitting material, and a glass frit and/or metallic components, and optionally, alumina powder. Variations in the composition can be used to adjust the viscosity and the final thickness of the printed film.

When alumina powder is present in the thick film paste, it is preferably of high purity and small particle size: for example, a d₅₀ of about 0.01 to about 5 microns, and preferably a d₅₀ of about 0.05 to about 0.5 microns (where d₅₀ refers to the median particle diameter of the powder particles). A combination of particle sizes within those ranges may also be used. When alumina powder is present in the thick film paste, the composition thereof may contain about 0.001 wt % to about 10 wt %, or about 0.01 wt % to about 6.0 wt % carbon nanotubes, and about 0.1 wt % to about 40 wt %, or about 1.0 wt % to about 30 wt %, or about 5 wt % to about 24 wt % alumina powder, both based on the total weight of all components of the paste composition. Additional filler types can also be combined with the alumina filler powder.

A preferred composition for use as a screen printable paste is one wherein the content of carbon nanotubes in the solids is less than about 9 wt %, or less than about 5 wt %, or less than 1 wt %, or in the range of about 0.01 wt % to about 2 wt %, based on the total weight of all solids in the paste.

The medium and solvent in the thick film paste composition are used to suspend and disperse the particulate constituents therein, i.e. the solids in the paste are provided with a suitable rheology, viscosity and volatility for typical patterning processes such as screen printing. Examples of materials suitable for use as an organic medium in as paste include cellulosic resins such as ethyl cellulose and alkyd resins of various molecular weights. Examples of materials suitable for use in a paste as a solvent include aliphatic alcohols; esters of such alcohols, for example, acetates and propionates; terpenes such as pine oil and alpha- or beta-terpineol, or mixtures thereof; ethylene glycol and esters thereof, such as ethylene glycol monobutyl ether and butyl cellosolve acetate; carbitol esters such as butyl carbitol, butyl carbitol acetate, dibutyl carbitol, dibutyl phthalate; and Texanol® (2,2,4-trimethyl-1,3-pentanediol monoisobutyrate). Examples of surfactants suitable for use to improve the dispersion of particles in a paste include organic acids such oleic and stearic acids, and organic phosphates such as lecithin.

If the thick film paste is to be photoimaged, the paste will typically also contain a photoinitiator, a developable binder; a photohardenable monomer such as a polymerizable ethylenically-unsaturated compound, including for example an acrylate and/or styrenic compound; and/or a copolymer prepared from a nonacidic comonomer such as a C₁₋₁₀ alkyl acrylate, C₁₋₁₀ alkyl methacrylate, styrenes, substituted styrenes or combinations thereof, and an acidic comonomer such as an ethylenically unsaturated carboxylic acid containing moiety. A photoinitiator system will have one or more compounds that directly furnish free radicals when activated by actinic radiation. Examples of photoinitiators suitable for use herein include benzophenone, Michler's ketone, p-dialkylaminobenzoate alkyl asters, polynuclear quinones, thioxanthones, hexaarylbiimidazoles, α-aminoketones, cyclohexadienones, benzoin and benzoin dialkyl ethers. The system may also contain a sensitizer that extends its spectral response towards or into the visible where the sensitizer is activated by the actinic radiation, and transfers energy to the photoinitiator system which furnishes free radicals. Examples of sensitizers include bis(p-dialkylaminobenzylidene) ketones (such as described in U.S. Pat. No. 3,652,275) and arylidene aryl ketones (such as described in U.S. Pat. No. 4,162,162).

The thick film paste is typically prepared by three-roll milling a mixture of electron emitting material; organic medium; surfactant; a solvent; an inorganic metal oxide powder, other inert (refractory) filler powder, low softening point glass frit, metallic powder, metallic paint or a mixture thereof; and, optionally, alumina powder. The paste mixture can be screen printed using well-known screen printing techniques, e.g. by using a 165-400-mesh stainless steel screen. The paste can be deposited as a continuous thick film or in the form of a desired pattern.

Carbon nanotubes are the preferred electron emitting material for use in the inventions hereof. Suitable CNTs for use herein include those prepared by laser ablation, such as described by Smalley et al in Science 273 (1996) 483 and in Chem. Phys. Lett. 243 (1995) 49; and by Popov in Mater. Sci. Eng. R. 43 (2004) 61. In a preferred embodiment, however, CNTs grown by thermal chemical vapor deposition (“CVD”) techniques are used as the electron emitting material for incorporation into a composition to provide a thick film paste. Thermal chemical vapor deposition is sometimes also referred to as thermal catalytic chemical vapor deposition or as thermal chemical vapor decomposition. As a result, for the purposes of this document, references to, or statements about, thermal chemical vapor deposition will be understood to also be references to or statements about thermal catalytic chemical vapor deposition or thermal chemical vapor decomposition, and vice versa.

The thermal CVD process for the preparation of carbon nanotubes may be carried out by cracking a gaseous hydrocarbon feed in a dehydrogenation reaction to decompose the hydrocarbon into carbon and hydrogen. Suitable feed gas hydrocarbons include methane, ethylene and acetylene. The reaction is carried out using transition metal nanoparticles, such as iron, nickel or cobalt, as a catalyst. The catalyst may be supported on a substrate such as mesoporous silica, graphite, zeolite, MgO or CaCO₃. The reaction may be run in a furnace at a temperature in the range of about 550° C. to about 1000° C., or about 750° C. to about 850° C. for a period of about 5 to about 60 minutes, or about 20 to about 30 minutes. The process may be carried out in a static environment, in a fluidized bed or on a belt furnace. Subsequent purification of the carbon nanotubes is usual and beneficial. Other aspects of the thermal CVD process for the preparation of carbon nanotubes are described by Popov in Mater. Sci. Eng. R. 43 (2004) 61 and by Harris in Ind. Eng. Chem. Res. 46 (2007) 997.

Thermal CVD carbon nanotubes suitable for use herein include, for example, those obtainable from Xintek, Swan, CNI and COCC. The Xintek CNTs are small-diameter CNTs obtainable from Xintek Inc., Chapel Hill N.C. The Swan CNTs are Elicarb CNTs (Product Reference Number PRO925) obtainable from Thomas Swan & Co. Ltd., Consett, England. The CNI CNTs are multi-walled CNTs obtainable from Carbon Nanotechnologies Inc., Houston Tex. The COCC CNTs are thin walled carbon nanotubes obtainable from Chengdu Chemical Company of Chengdu (COCC), Chengdu, China.

Thermal CVD carbon nanotubes are typically thin walled carbon nanotubes with outer diameters of greater than about 1.4 nm to about 5 nanometers. They are typically thin walled, multi walled carbon nanotubes that contain up to 10 walls. Transmission electron microscope (TEM) images of thin walled CNTs show a range of wall counts from 2 to 10, with very few single walled CNTs present. Blends of different kinds of thermal CVD carbon nanotubes may be used as well, however.

Laser ablated CNTs are primarily single walled CNTs with diameters of about 1.2- to less than about 1.4 nm (nanometers). The chirality of laser CNTs is primarily 10,10 (i.e. n=10 and m=10 describes the tube chirality) and the tubes are primarily metallic (vs semiconducting) in character.

The next step of the methods hereof to make a cathode assembly is heating a patterned thick film paste, applied to a substrate as described above, at a temperature in the range of about 300° C. to about 550° C. in air or in another oxidizing atmosphere. An oxidizing atmosphere is a gas or mixture of gasses containing oxygen and/or other gaseous oxidizing agents. Examples of gaseous oxidizing agents are ozone, nitrous oxide and chlorine although oxygen is by far the most common and practical oxidizing agent. An oxidizing atmosphere may contain an oxidizing agent in widely varying amounts such as about 100 ppm, about 0.1% by weight, or 100% by weight, and values in the ranges therebetween. The most common oxidizing atmosphere in use is air, which is typically 21 percent oxygen by volume.

The layers of the cathode assembly on which the layer of paste has been deposited are heated to cure the paste for a period that is typically between about 10 and about 60 minutes at peak temperature. When the substrate is glass, the assembly may be fired at a temperature of about 350° C. to about 550° C., or of about 400° C. to about 475° C., for about 30 minutes in air or other oxidizing atmosphere. Higher firing temperatures can be used with substrates that can endure them up to about 525° C. However, the organic constituents in the paste are effectively volatilized at about 350 to about 400° C., which leaves a layer of a composite containing acicular carbon, inorganic metal oxide powders (such as alumina powder) when they have been included, other inert (refractory) filler powders, filler glass and/or metallic conductors, and amorphous carbon. At a firing temperature below 300° C., there is usually incomplete removal of the organic vehicle. At a firing temperature above 550° C., the performance of the electron field emitter may be degraded. At still higher temperatures, the substrate may suffer deformation, depending on the thermal characteristics of the material from which it is made.

Firing may also occur at a temperature that is about 300° C. or more, or about 325° C. or more, or about 350° C. or more, or about 375° C. or more, or about 400° C. or more, or about 425° C. or more, or about 450° C. or more, or about 475° C. or more, or about 500° C. or more, or about 525° C. or more, and yet that is about 550° C. or less, or about 525° C. or less, or about 500° C. or less, or about 475° C. or less, or about 450° C. or less, or about 425° C. or less, or about 400° C. or less, or about 375° C. or less, or about 350° C. or less, or about 325° C. or less.

In general, thick film pastes, such as those containing laser ablation CNTs, have conventionally been heated in a nitrogen or an otherwise inert atmosphere, or in a vacuum, when the temperature exceeds about 300° C. Providing an inert atmosphere or a vacuum requires a chamber, and thus adds undesirable complexity and cost to the method of cathode assembly production. The penalty for not heating conventional thick film pastes in an inert atmosphere or a vacuum, however, is that the performance of the field emitter is typically degraded, and this result may be seen even when there is a very low level of oxygen in the atmosphere such as in the range of about 100 ppm to about 0.1 wt %. Degradation in field emitter performance may take the form of reduced emission current or increased operating field, or both.

In the methods of this invention, however, fabrication of a cathode assembly may involve heating a thick film paste to temperatures in excess of 300° C. in the presence of air or other oxidizing atmosphere without causing a degradation in the performance of the electron field emitter. That is, the performance of a field emitter obtained when it is oxygen fired at greater than 300° C., as herein, is at least as good as the performance obtained from a conventional field emitter that is either oxygen fired at less than 300° C., or is fired in an inert atmosphere at greater than 300° C. In the field emitter of a cathode assembly hereof, the presence in the thick film paste of thermal CVD carbon nanotubes and/or alumina powder provides a material that tolerates heating to temperatures in excess of 300° C. in the presence of air or other oxidizing atmosphere to retain its capacity for the production of high emission currents at low operating fields.

Using photoimageable silver, a dielectric material, and carbon nanotube/silver emitter pastes prepared as described above, a thick film-based, field emission triode array may be constructed having the schematic design as shown in FIG. 1. In a field emission triode as shown in FIG. 1 (a “normal gate triode”), the gate electrode is located physically between the cathode, which is the electron field emitter, and the anode. The gate electrode in such design is considered part of the cathode assembly. The cathode assembly consists of a cathodic current feed as a first layer deposited on the surface of a substrate. A dielectric layer, containing circular or slot shaped vias, forms a second layer of the device. A layer of electron emitting material is in contact with the conductive cathode within the vias, and its thickness may extend from the base to the top of the dielectric layer. A gate electrode layer, deposited on the dielectric but not in contact with the electron emitting material, forms the top layer of the cathode assembly. It is preferred that, in the cathode assembly, the dimensions of the via diameter, the dielectric thickness, and the distance between the gate and the electron emitting material be minimized to achieve optimized low voltage switching of the triode.

A cathode assembly for a triode array as shown in FIG. 1 may be fabricated by the following steps:

(a) print on a substrate a photoimageable silver cathode layer, photoimage and develop the silver cathode layer, and then fire it to produce silver cathode feed lines on the substrate;

(b) print a photoimageable electron field emitter layer on top of the silver cathode feed lines and the exposed substrate, photoimage and develop the electron field emitter layer into dots, rectangles or lines on the silver cathode feed lines;

(c) print one or more uniform photoimageable layers of dielectric material on top of the silver cathode feed lines and the electron field emitter layer, and dry the dielectric,

(d) print a layer of photoimageable silver gate lines on top of the dielectric layer, and dry this layer of silver gate lines,

(e) image both the silver gate and the dielectric layers in a single exposure with a photo-mask containing a via or slot pattern to place the vias directly on top of the dots, rectangles or lines into which the electron field emitter layer has been formed, and

(f) develop the silver gate and dielectric layers to reveal the electron field emitter layer at the base of the vias, and co-fire the electron field emitter, dielectric, and silver gate layers under conditions as described above.

In step (b) as set forth above, the alignment of the subsequent dielectric and gate layers can be simplified if the size of the dots, rectangles or lines of the electron field emitter layer are significantly larger than the final via dimension. Alternatively, this electron field emitter layer may be fabricated by simple screen printing if this can be accomplished for the desired pitch density of the array and will not require the use of a photoimageable emitter paste. In step (d), if the pitch density is too high for the printing of silver gate lines, a uniform layer of photoimageable silver can be printed, and the lines can be subsequently formed in the imaging step (e) using a mask with a silver gate line and via pattern.

In the process described above, excellent, if not perfect, registration of the gate, via and electron field emitter components can be achieved without an alignment step when photoimageable thick films are used. More importantly, this process prevents the formation of shorts between the gate and electron field emitter layers while at the same time achieving minimum gate to emitter separation.

As a next step that is preferred but not required, the cathode assembly may be activated by one of two methods, depending on other requirements of the materials used in the cathode. The first method is by applying an adhesive tape with pressure to the top surface of the layer of emitting material on the cathode electrode, and subsequently stripping it to remove the top layer of the emitting material. The second method of activation is by applying a layer of liquid elastomer adhesive to the top surface of the emitting material, and curing it by heat or UV radiation or both, and subsequently stripping it off to remove the top layer of the emitting material. In either method of activation, it is more common to carry out the activation step after the emitting material has been fired. Notwithstanding that one preferred thick film paste composition herein contains carbon nanotubes, an optional alumina powder and an organic vehicle, in other embodiments, adding additional inorganic powders such as colloidal silica to the composition will provide superior adhesion of the carbon nanotubes.

After the cathode assembly is fabricated and activated, it is combined with an anode and together they constitute the top and the bottom of a sealed panel. At this stage, if the gate is not built onto the cathode assembly it may be added as a separate grid placed over the cathode electrode before the cathode assembly and anode are sealed into a panel. Typically, the panel is sealed using sealing glass at temperatures where the sealing glass softens, which can approach 500° C. A vacuum is generated by pumping on the panel during and after sealing Getters may also be used to obtain the required vacuum.

This invention thus involves the further steps of incorporating a substrate on which a thick film paste has been deposited and patterned, or a cathode assembly containing such a substrate, into an electron field emitter. The electron field emitter may in turn be activated and/or incorporated into a field emission device. The field emission device may in turn be incorporated into a flat panel display.

The advantageous attributes and effects of the subject matter hereof may be more fully appreciated from a series of examples as described below. The embodiments of the methods hereof on which the examples are based are representative only, and the selection of those embodiments to illustrate the invention does not indicate that materials, conditions, components, regimes, reactants or techniques not described in these examples are not suitable for practicing these methods, or that subject matter not described in these examples is excluded from the scope of the appended claims and equivalents thereof.

### EXAMPLES

### Example 1

Four different fillers were made into four different thick film emitter compositions. All of the pastes had the same ingredient lots and composition except that a different filler was used in each. Each of the filler powders was made into a filler pre-paste that contained 50 wt % powder and 50 wt % organic medium. These pre-pastes were incorporated into the final pastes, all of which used the same organic medium (Medium 1-1). Each filler pre-paste was roll milled on a three roll mill at up to 300 psi.

| Designation | Filler Description |
|---|---|
| A-1 | Taimei TM-50 Alumina Powder |
| B | Fisher Scientific Zirconia Powder Z83-500 |
| C | Alfa Aesar Titanium Carbide Powder STK40178 |
| D | Alfa Aesar Silicon Carbide Powder Lot L23E04 |

The Tamei TM-50 alumina powder was obtained from Taimei Chemical Company, Ltd, Tokyo, Japan (particle size d₅₀=0.21 microns). The ZrO₂ powder Z83-500 (Lot FKP981) was obtained from Fisher Scientific, Springfield N.J. (particle size d₅₀=12.3 microns). The titanium carbide powder (Lot D24F36) was obtained from Alfa Aesar, a Johnson Matthey company, Ward Hill Mass. (particle size d₅₀=2.27 microns). The silicon carbide powder was obtained from Alfa Aesar, a Johnson Matthey company, Ward Hill Mass. (particle size d₅₀=0.31 microns).

In parallel, a slurry of the CNTs in ethyl acetate was prepared by sonicating a solution of CNTs (1 wt %) in beta-terpineol (2.5 wt %) and ethyl acetate (96.5 wt %). The CNTs were carbon nanotubes made by laser ablation from DuPont, Wilmington Del. The beta-terpineol and ethyl acetate were standard reagent grade chemicals. The mixture of CNTs in solvent was sonicated with a VWR sonifier 450 with a ½″ horn. Then the CNT slurry was combined with the medium and filler paste according to the following formulation. Each of the 4 filler pre-pastes was made into a separate final paste mixture.

| Material | From | Percent |
|---|---|---|
| Medium 1-1 | See following | 71.2 |
| Beta-Terpineol | | 3.6 |
| Filler pre-paste | Pre-paste above | 23.8 |
| CNTs | From slurry above | 1.4 |

Medium 1-1 was a medium that could be photoimaged by UV light containing a (meth)acrylate monomer; a copolymer of a nonacidic comonomer an acidic comonomer; a photoinitiator; and a solvent. The filler powder was made into a filler pre-paste which was 50 wt % alumina powder and 50 wt % organic medium (Medium 1-1). The filler pre-paste was roll milled on a three roll mill at up to 300 psi. The filler pre-paste was used in preparing each thick film pastes, each of which used the same organic medium (Medium 1-1). The ethyl acetate was evaporated from the final paste mixture by heating the mixture on a hot plate while stirring with an air purge. Samples were then roll milled on a three roll mill for three passes at zero psi and two passes at 100 psi.

The ethyl acetate was evaporated by heating the mixture on a hot plate while stirring with an air purge. Samples were roll milled for three passes at zero psi and two passes at 100 psi. Samples were printed through a 325 mesh stainless steel thick film printing screen with a 1¾″ square pattern on to a 2″×2″ ITO coated substrate. The screen had a 0.6 mil E-11 emulsion and a pattern of 20 micron dots. The samples were imaged for 27.5 seconds at 500 watts, developed with 4:1 NMP:H₂O in 90 seconds (NMP is 1-methyl-2-pyrrolidinone available from Alfa Aesar, a Johnson Matthey company, Ward Hill Mass.). Samples were fired in a 4 zone belt furnace with a peak temperature at 420° C. for 6 minutes using a nitrogen atmosphere with 0.1 wt % oxygen.

The fired emitter layer on the cathode was activated to improve field emission by applying a layer of liquid elastomer adhesive that was coated on the cathode. Doctor blade coating of the liquid elastomer was used to coat a 40 micron thick layer. The adhesive material was cured to a solid coating by heating or by UV exposure. When the relative adhesion between the fired electron field emitter material and the adhesive coating was properly balanced, peeling of the cured adhesive layer lead to the removal of the adhesive coating from the cathode and an improved emission of the electron field emitters. The surface layer of the fired electron field material was removed with the cured adhesive coating.

Diode testing was carried out by combining the cathode assembly produced as described above with an anode at a preselected separation distance, and applying a voltage between them in a vacuum chamber to measure emission currents, or the fields required to produce a particular current. The 5 minute emission current was measured after the diode panel had been operating for 5 minutes in the vacuum chamber. The emission current data are presented in Tables 1-1 and 1-2. The emission current is in micro amps.

TABLE 1-1
Alumina Filler

| | Initial Emission | 5 Minute Emission |
|---|---|---|
| Filler | Current | Current |
| A-1 | 85 | 90 |
| A-1 | 72 | 80 |

TABLE 1-2
Non-Alumina Fillers

| | Initial Emission | 5 Minute Emission |
|---|---|---|
| Filler | Current | Current |
| B | 21 | 28 |
| B | 24 | 34 |
| C | 19 | 25 |
| C | 19 | 34 |
| D | 45 | 62 |
| D | 64 | 73 |

When fired at 420° C. in a nitrogen atmosphere containing 0.1 wt % oxygen, compositions containing alumina had higher emission currents than compositions containing any of the other fillers.

### Example 2

The preparation and testing of the emitter paste compositions in Example 2 are similar to that described for the compositions in Example 1. Various levels of alumina were added to the emitter composition to demonstrate the effect on emitter current when fired in a nitrogen atmosphere containing 0.1 wt % oxygen.

The CNTs used were made by laser ablation by DuPont, Wilmington Del. The frit powder (d₅₀=1.2 microns) was made from Viox glass #24109 from Viox Corporation, Seattle Wash. Filler A-1 was Tamei TM-50 alumina powder obtained from Taimei Chemical Company, Ltd., Tokyo, Japan (particle size was d₅₀=0.21 microns). Filler A-2 was alumina powder AKP-20 obtained from Sumitomo Chemical, Tokyo, Japan (d₅₀=0.5 micron). The indium oxide (“ITO”) powder was Lot KS5112 from Indium Corporation of America, Utica N.Y.

Samples were fired in a 4 zone belt furnace with a peak temperature at 420° C. for 6 minutes using a nitrogen atmosphere with 0.1 wt % oxygen.

A cathode assembly was made and activated for each sample as described in Example 1. Diode testing was carried out by combining each cathode assembly with an anode at a preselected separation distance and applying a voltage between them in a vacuum chamber to measure emission currents, or the fields required to produce a particular current. The 5 minute emission current was measured after the diode panel had been operating for 5 minutes in the vacuum chamber. The emission current data are presented in Tables 2-1 and 2-2. The emission current is in micro amps.

TABLE 2-1
Non-Alumina Fillers

| | | 5 Minute Emission |
|---|---|---|
| Filler | % Filler | Current |
| Frit | 11.9 | 6 |
| Frit | 11.9 | 10 |
| Frit | 11.9 | 8 |
| Frit | 11.9 | 8 |
| In2O3 | 11.9 | 6 |

TABLE 2-2
Alumina Fillers

| | | 5 Minute Emission |
|---|---|---|
| Filler | % Filler | Current |
| A-1 | 10.6 | 106 |
| A-1 | 10.6 | 112 |
| A-1 | 10.6 | 147 |
| A-1 | 10.6 | 123 |
| A-1 | 2.5 | 71 |
| A-1 | 2.5 | 60 |
| A-1 | 5 | 59 |
| A-1 | 5 | 70 |
| A-1 | 7.5 | 102 |
| A-1 | 7.5 | 99 |
| A-1 | 10 | 112 |
| A-2 | 11.9 | 104 |
| A-2 | 11.9 | 108 |
| A-2 | 7.5 | 112 |
| A-2 | 7.5 | 110 |
| A-2 | 5 | 66 |
| A-2 | 5 | 61 |
| A-2 | 2.5 | 65 |
| A-2 | 2.5 | 68 |
| A-2 | 20 | 127 |
| A-2 | 20 | 113 |

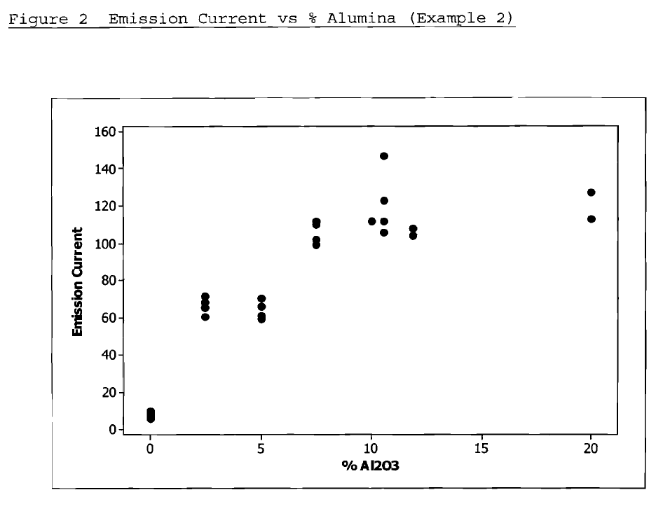

The data from Example 2 are plotted in FIG. 2.

When fired at 420° C. in a nitrogen atmosphere containing 0.1 wt % oxygen, thick film emitter compositions containing 7.5 wt % or more alumina had desirably high emission currents.

### Example 3

Samples of emitter paste compositions were prepared for firing in a belt furnace with 0.1 wt % oxygen in a nitrogen atmosphere. The preparation and testing of the paste compositions are similar to that described for the compositions in Example 1.

The laser CNTs were made by laser ablation by DuPont, Wilmington Del. The CNI CNTs were multi walled field emission grade CNTs obtained from Carbon Nanotechnologies Inc., Houston Tex. The Xintek CNTs were small-diameter CNTs with field emission properties obtained from Xintek Inc., Chapel Hill N.C. The frit powder (d₅₀=1.2 microns) was made from Viox glass #24109 from Viox Corporation, Seattle Wash. Filler A-2 was alumina powder AKP-20 from Sumitomo Chemical, Tokyo, Japan (d₅₀=0.5 micron).

A cathode assembly was made and activated as described in Example 1 for each sample. Samples were fired in a 4 zone belt furnace with a peak temperature at 420° C. for 6 minutes using a nitrogen atmosphere with 0.1 wt % oxygen. Diode testing was carried out by combining each cathode assembly with an anode at a preselected separation distance and applying a voltage between them in a vacuum chamber to measure emission currents, or the fields required to produce a particular current. The emission current data are presented in Tables 3-1 and 3-2. The emission current is in micro amps.

TABLE 3-1
Non-Alumina Fillers

| | | | Initial | 5 Minute |
|---|---|---|---|---|
| | | | Emission | Emission |
| Filler | CNT Type | % Filler | Current | Current |
| Frit | Laser | 11.5 | 6.9 | 8.2 |
| Frit | Laser | 11.5 | 3.6 | 4.1 |
| Frit | CNI | 11.5 | 1.4 | 2.0 |
| Frit | CNI | 11.5 | 0.8 | 1.2 |
| Frit | Xintek | 11.5 | 0.002 | 0.004 |

TABLE 3-2
Alumina Fillers

| | | | Initial | 5 Minute |
|---|---|---|---|---|
| | | | Emission | Emission |
| Filler | CNT Type | % Filler | Current | Current |
| A-2 | Laser | 11.5 | 87.2 | 93.5 |
| A-2 | Laser | 11.5 | 80.4 | 92.9 |
| A-2 | Laser | 11.5 | 137.3 | 125.2 |

At the same filler loading, the emission current for laser CNTs with alumina filler is higher than for laser CNTs without alumina or for two other CNT types without alumina.

### Example 4

CNTs from different sources were tested in compositions with alumina powder and fired in nitrogen. These results were compared to firing in air. The nitrogen fired results are given in Table 4-1. The data from firing at two different temperatures (400° C. and 450° C.) in air are presented in Tables 4-1 and 4-2.

The filler powder was made into a filler pre-paste which was 25 wt % fine alumina powder and 75 wt % organic medium (Medium 4-1—see below). The filler pre-paste was roll milled on a three roll mill at up to 300 psi. These filler pre-pastes were used in preparing the emitter thick film pastes. The pastes were prepared by the following formulation, which followed the procedures of Example 1. However, these pastes had different filler and organic medium ingredients from those used in Example 1.

| Material | Source | Weight % |
|---|---|---|
| A-3 | Allied High Tech Products | 8.8 |
| Medium-4-1 | See below | 75.3 |
| Medium-4-2 | See below | 14.8 |
| CNTs | CNI or Xintek or Swan | 0.3 |
| Terpineol | | 0.8 |

The CNI CNTs were multi walled field emission grade CNTs from Carbon Nanotechnologies Inc., Houston Tex. The Xintek CNTs were small-diameter CNTs with field emission properties from Xintek, Inc., Chapel Hill N.C. The Swan CNTs were Elicarb CNTs (Product Reference Number PRO925) from Thomas Swan & Co. Ltd., Consett, England. The filler (A-3) was alumina powder from Allied High Tech Products, Rancho Dominguez Calif. (d₅₀=0.05 micron). Medium 4-1 was 10% N-22 ethyl cellulose in terpineol (the N-22 ethyl cellulose was obtained from The Dow Chemical Company, Midland Mich.). Medium 4-2 was 13% Aqualon T-200 ethyl cellulose in terpineol (the T-200 ethyl cellulose was obtained from Hercules Inc., Wilmington Del.).

The thick film paste was patterned by screen printing in a series of 100 micron wide lines. The substrate was 2″×2″ ITO coated glass. Samples were fired in a 10 zone belt furnace at 420° C. peak temperature for 20 minutes using a nitrogen atmosphere.

Cathode assemblies were activated by applying an adhesive tape with pressure to the top surface of the emitter layer on the cathode electrode and subsequently stripping it to remove the top layer of the fired emitting material. The adhesive tape was obtained from Adhesives Research, Glen Rock Pa. Diode testing was carried out by combining the cathode assembly with an anode at a preselected separation distance and applying a voltage between them in a vacuum chamber to measure emission currents, or the fields required to produce a particular current. The field necessary to generate a 36 micro amp current was recorded, and the data are presented in Tables 4-1, 4-2 and 4-3. The field is in volts per micron.

TABLE 4-1
Fired 420° C. in nitrogen

| | | | Field at 36 |
|---|---|---|---|
| Filler | CNT Type | % Filler | micro amps |
| A-3 | CNI | 8.8 | 3.06 |
| A-3 | CNI | 8.8 | 3.13 |
| A-3 | CNI | 8.8 | 2.83 |
| A-3 | Xintek | 8.8 | 2.69 |
| A-3 | Xintek | 8.8 | 2.76 |
| A-3 | Xintek | 8.8 | 2.58 |
| A-3 | Swan | 8.8 | 2.86 |
| A-3 | Swan | 8.8 | 2.95 |
| A-3 | Swan | 8.8 | 2.80 |

Additional cathode samples were fired in a 10 zone belt furnace at 400° C. peak temperature for 20 minutes using an air atmosphere. The field necessary to generate a 36 micro amp current is stated in volts per micron.

TABLE 4-2
Fired 400° C. in air

| | | | Field at 36 |
|---|---|---|---|
| Filler | CNT Type | % Filler | micro amps |
| A-3 | CNI | 8.8 | 2.71 |
| A-3 | CNI | 8.8 | 2.67 |
| A-3 | CNI | 8.8 | 2.63 |
| A-3 | Xintek | 8.8 | 2.63 |
| A-3 | Xintek | 8.8 | 2.55 |
| A-3 | Xintek | 8.8 | 2.54 |
| A-3 | Swan | 8.8 | 2.93 |
| A-3 | Swan | 8.8 | 2.89 |
| A-3 | Swan | 8.8 | 2.92 |

Additional cathode samples were fired in a 10 zone belt furnace with a 450° C. peak temperature for 20 minutes using an air atmosphere. The field necessary to generate a 36 micro amp current is stated in volts per micron.

TABLE 4-3
Fired 450° C. in air

| | | | Field at 36 |
|---|---|---|---|
| Filler | CNT Type | % Filler | micro amps |
| A-3 | CNI | 8.8 | 2.77 |
| A-3 | CNI | 8.8 | 3.13 |
| A-3 | CNI | 8.8 | 3.40 |
| A-3 | Xintek | 8.8 | 2.84 |
| A-3 | Xintek | 8.8 | 2.83 |
| A-3 | Swan | 8.8 | 3.08 |
| A-3 | Swan | 8.8 | 3.13 |
| A-3 | Swan | 8.8 | 3.32 |

The fields are similar for these compositions, which all contain alumina powder, whether the emitter materials are fired in air or nitrogen at temperatures of 400 to 450° C. or nitrogen at 420° C.

### Example 5

Emitter thick film paste compositions were made according to the formulas and procedures of Example 1. Only the components as specified in Tables 5-1 and 5-2 were changed.

The laser CNTs were made by laser ablation by DuPont, Wilmington Del. The frit powder (d₅₀=1.2 microns) was made from Viox glass #24109 from Viox Corporation, Seattle Wash. Filler A-2 was alumina powder AKP-20 from Sumitomo Chemical, Tokyo, Japan (d₅₀=0.5 micron).

Cathode assemblies were made and activated as described in Example 1. Samples were fired in a 4 zone belt furnace with a peak temperature at 420° C. for 6 minutes using a nitrogen atmosphere with 0.1 wt % oxygen. Diode testing was carried out by combining the cathode assembly with an anode at a preselected separation distance and applying a voltage between them in a vacuum chamber to measure emission currents, or the fields required to produce a particular current. The 5 minute emission current was measured after the diode panel had been operating for 5 minutes in the vacuum chamber. The emission current data are presented in Tables 5-1 and 5-2. The emission current is in micro amps.

TABLE 5-1
Non-Alumina Filler

| | | | Initial | 5 Minute |
|---|---|---|---|---|
| | | | Emission | Emission |
| Filler | CNT Type | % Filler | Current | Current |
| Frit | Laser | 11.9 | 6 | 6 |
| Frit | Laser | 11.9 | 9 | 10 |

TABLE 5-2
Alumina Filler

| | | | Initial | 5 Minute |
|---|---|---|---|---|
| | | | Emission | Emission |
| Filler | CNT Type | % Filler | Current | Current |
| A-2 | Laser | 11.9 | 108 | 106 |
| A-2 | Laser | 11.9 | 106 | 112 |

The emission currents for the emitter paste containing alumina powder were higher than the emission currents for the composition containing frit as the filler.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

What is claimed is:

1. A method of depositing an electron emitting material on a substrate, comprising:
(a) providing a substrate,
(b) admixing components comprising (i) carbon nanotubes, (ii) alumina powder, and (iii) an organic vehicle to form a composition, wherein the concentration of the alumina powder is 5 to 24 percent by weight by weight of the total composition,
(c) depositing a pattern of a thick film of the composition on the substrate, and
(d) heating the pattern of the thick film at a temperature between 300° C. and 550° C. in an air or oxidizing atmosphere.

2. A method according to claim 1 wherein the substrate is electrically conductive.

3. A method according to claim 1 further comprising a step of depositing a pattern of electrical conductor on the substrate before depositing a pattern of a thick film of the composition.

4. A method according to claim 1 wherein the substrate is electrically insulating.

5. A method according to claim 4 further comprising a step of depositing an electrical conductor on the electrically insulating substrate before depositing a pattern of a thick film of the composition.

6. A method according to claim 1 wherein the alumina powder has a particle size with a d50 of 0.01 to 5 microns.

7. A method according to claim 1 wherein the alumina powder has a particle size with a d50 of 0.05 to 0.5 microns.

8. A method according to claim 1 wherein the concentration of alumina powder in the composition is 7.5 to 20 percent by weight by weight of the total composition.

9. A method according to claim 1 wherein the concentration of carbon nanotubes in the composition is about 0.01 to about 2 percent by weight by weight of the total composition.

10. A method according to claim 1 which comprises screen printing the composition to deposit a pattern of the composition.

11. A method according to claim 1 which comprises spraying the composition to deposit a pattern of the composition.

12. A method according to claim 1 which comprises photoimaging the composition to form a patter thereof.

13. A method according to claim 1 wherein the composition further comprises colloidal silica.

14. A method according to claim 1 further comprising a step of incorporating the substrate into an electron field emitter.

15. A method according to claim 14 further comprising a step of activating the electron field emitter.

16. A method according to claim 14 further comprising a step of incorporating the electron field emitter into a field emission device.

17. A method according to claim 16 further comprising a step of incorporating the field emission device into a flat panel display.
